(19) United States
(12) Patent Application Publication
(10) Pub. No.: US 2002/0175625 A1
(43) Pub. Date: Nov. 28, 2002

(54) Low-pressure discharge lamp

(75) Inventors: Roland Hoffmann, Augsburg (DE); Franz Stoll, Meitingen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MGH, MUNCHEN (DE)

(21) Appl. No.: 10/105,410

(22) Filed: Mar. 26, 2002

(30) Foreign Application Priority Data
Apr. 6, 2001 (DE) 10117365.2

(51) Int. Cl. H01J 17/20

(52) U.S. Cl. 313/637

(57) ABSTRACT

The invention discloses a low-pressure discharge lamp (1) having a discharge vessel (2) which contains mercury. To prevent mercury from being consumed, a reducing agent (20) is introduced into the discharge vessel (2), which reducing agent is such that it bonds oxygen in the temperature range between room temperature and temperatures up to 900° C. and can reduce mercury oxide.

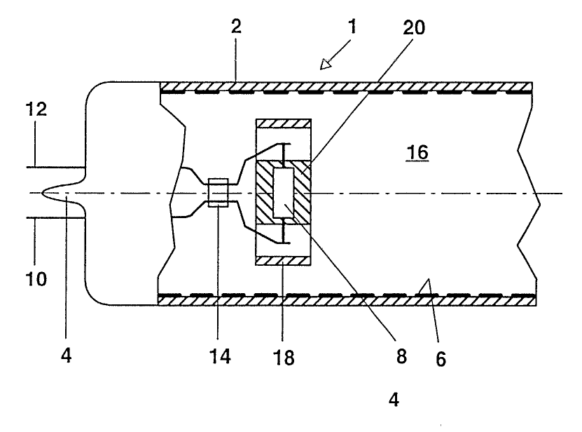

### TECHNICAL FIELD

The invention relates to low pressure discharge lamp having a discharge vessel which accommodates two electrodes and in which a fill comprising mercury and at least one inert gas is accommodated. The invention relates additionally to a reducing agent for a low-pressure discharge lamp.

### BACKGROUND ART

Low-pressure discharge lamps of this type, which are known, for example, from EP 0 569 814 B1, are generally referred to as fluorescent lamps. A discharge vessel of these lamps contains a fill comprising at least one inert gas and mercury. The inner peripheral wall of the discharge vessel is coated with phosphors, the chemical composition of which determines the spectrum of the light which is emitted and the hue. During firing and operation of the fluorescent lamp, radiation in the ultraviolet region is emitted on account of a mercury vapor discharge. This UV light is converted by the phosphor mixture into the light which is emitted by the lamp.

During the production of low-pressure discharge lamps of this type, it is attempted to meter the mercury as accurately as possible, since, on the one hand, the high toxicity of the mercury causes considerable problems during disposal of the lamps and, secondly, for quality reasons it is necessary to maintain the mercury content in order to achieve the desired light efficiency. A further problem of low-pressure lamps of this type is that, when the fluorescent lamps are operating, a certain consumption of mercury is observed, which is caused firstly by the formation of oxides or by reaction with the phosphors and other materials in the discharge vessel. In fluorescent lamps which use advanced production technology, i.e. use a protective coating on the lamp bulb, high-quality rare-earth phosphors, etc., the consumption of mercury is substantially determined only by the formation of oxides.

DE 696 08 996 D2 has described a method for introducing mercury, in which the mercury is introduced in the form of an intermetallic compound with a carrier material. This carrier material also acts as a getter, by means of which traces of undesirable gases present in the discharge vessel can be bonded.

However, it has been found that even the use of a getter substance of this type cannot prevent the consumption of mercury through the formation of mercury oxide. It is therefore necessary for a greater quantity of mercury than would theoretically be necessary for operation of the lamp to be introduced into the discharge vessel, so that it is ensured that sufficient pure mercury is present in the discharge vessel throughout the entire minimum service life of the lamp.

It has already been attempted to avoid the consumption of mercury through the formation of mercury oxides by minimizing the introduction of oxygen into the lamps. However, this requires a considerable outlay on process technology. Since, furthermore, the emitter which has been applied to the electrodes of the low-pressure discharge lamp is produced substantially on the basis of metal oxides, it is impossible to prevent oxygen from being released during operation of the lamp through reduction of the emitter metal oxides.

### DISCLOSURE OF THE INVENTION

By contrast, the invention is based on the object of providing a low-pressure discharge lamp in which a minimal quantity of mercury is to be introduced into the discharge vessel.

This object is achieved by a low-pressure discharge lamp having a discharge vessel which accommodates two electrodes and in which a fill comprising mercury and at least one inert gas is accommodated, and a reducing agent, by means of which oxygen which is present in the discharge vessel is bonded in the temperature range between room temperature and temperatures up to 900° C. and mercury oxide can be reduced. Additionally this object is achieved by a reducing agent for a low-pressure discharge lamp having a substance A which takes up oxygen at room temperature and a substance B which, under discharge conditions and higher temperatures up to 900° C., reduces the oxide of the substance A and the mercury oxide and bonds oxygen which is released.

According to the invention, a discharge vessel of a low-pressure discharge lamp contains a reducing agent which is able to reduce the mercury oxide contained in the discharge vessel and to irreversibly bond the oxygen both at room temperature and at higher temperatures of up to 900° C., as are encountered for example under discharge conditions. This means that, according to the invention, at room temperature and under discharge conditions not only is the oxygen which is present in the discharge vessel bonded, but also existing mercury oxides, which are present, for example, during introduction of the mercury or are formed during operation, are also reduced. This solution allows the consumption of mercury to be minimized, so that only a relatively small amount of mercury is required for operation of the lamp. This makes it possible to observe the upper limits which are becoming increasingly stringent throughout Europe and are set by the legislature.

The reducing agent must be selected in such a way that the formation of mercury oxide is avoided or suppressed both at room temperature and at higher temperatures.

According to the invention, it is preferable if the reducing agent consists of two substances. A substance A which is able to bond the oxygen at room temperature. Furthermore, the reducing agent contains a substance B which, at higher temperatures, irreversibly bonds the oxygen released by the substance A and reduces mercury oxide, i.e. the two substances A, B complement one another, so that reduction of the mercury oxide and bonding of the oxygen is ensured throughout the entire temperature range. Mixing suitable substances allows this reduction capacity of the reducing agent according to the invention to be optimally matched to the operating conditions of the low-pressure discharge lamp.

It is particularly preferred if the substance A is a metal or a metallic compound but not an amalgam-forming agent, while the substance B contains a material whose oxide has a higher bonding energy than the oxide of the substance A, so that, under discharge conditions and at higher temperatures, it can reduce the oxide of the substance A and can bond the oxygen.

Tests have shown that a mixture of Fe and Zr is a suitable reducing agent, the mixing ratio being approximately 4:1. Naturally, it is also possible to use other substances which have the properties described above.

Production of the low-pressure discharge lamp is also simple if the substance A, when it is being introduced, undesirably contains oxides and the substance B is selected in such a way that it reduces these oxides and the mercury oxide at higher temperatures and stores the oxygen which is released.

The reducing agent according to the invention is preferably introduced into the discharge vessel as a powder or shaped body.

The structure of the low-pressure discharge lamp is particularly simple if the reducing agent is introduced as a coating of a substrate, to which getter substances are also applied.

The action of the reducing agent can be improved if, after it has been introduced into the discharge chamber, it is activated by increasing the temperature and/or by interaction with a high-frequency field, so that the undesirably oxidized substance A is reduced to form the pure metal and thereby recovers its reducing activity at low temperatures.

Other advantageous refinements of the invention form the subject matter of the further subclaims.

### BEST MODE FOR CARRYING OUT THE INVENTION

A preferred exemplary embodiment of the invention is explained in more detail below with reference to a diagrammatic drawing.

The figure shows a diagrammatic sectional illustration of a discharge vessel 2 of a low-pressure discharge lamp 1. This discharge vessel 2 has a glass shell, which may be cylindrical or, in the case of what are known as compact lights, may be ring-shaped or U-shaped. To fill the discharge vessel 2, a small pump tube 4 is formed at an end face, which is formed, for example, by pinching, of the discharge vessel 2, which tube is melted down after the filling operation. The inner peripheral wall of the discharge vessel 2 is provided with a phosphor coating 6. In the case of high-quality fluorescent lamps, they contain, for example, rare-earth phosphors.

The discharge vessel 2 also includes two electrodes, of which only one electrode, 8, is illustrated in the figure. This electrode 8 may be formed, for example, by a filament which is connected to connection pins (not shown) of the low-pressure discharge lamp 1 via two supply conductors 10, 12.

To secure the supply conductors 10, 12 they are held together inside the discharge vessel 1 by a bead of glass 14. The electrodes 8, which consist of tungsten wire, are coated with an emitter, which makes it easier for the electrons to escape into a discharge chamber 16 of the discharge vessel 2.

In the exemplary embodiment illustrated, the electrode 8 is surrounded by an annular cap 18, which ensures that the materials which are vaporized from the electrode during firing and during operation of the lamp 1 do not cause any blackening of the bulb.

During filling, at least one inert gas, generally krypton and/or argon, is introduced through the small pump tube 4 at a pressure of approximately 10³ Pa. The mercury may be supplied directly or—as mentioned in the introduction—as an intermetallic compound, for example TiₓZr_{y}Hg_{z}.

Furthermore, the discharge chamber 16 also holds a reducing agent 20 according to the invention, which is introduced, for example, as a shaped body or in powder form.

In the exemplary embodiment illustrated in the figure, the annular cap 18 which engages around the electrode 8 is cut open in the peripheral region, so that the reducing agent 20 according to the invention can be introduced into the gap formed. This reducing agent can, for example, be pressed into a shaped body and inserted into the annular cap 18 or can be fixed by means of a supporting structure, for example a wire mesh.

A particularly expedient solution consists in the reducing agent 20 being introduced into the discharge vessel 2 in the form of tablets or on a substrate material, to which a getter substance has also been applied or which also contains a getter substance. For example, the annular cap 18 could include peripheral recesses which contain the getter material and the reducing agent according to the invention in the form of a mixture or separately from one another.

As has already been mentioned in the introduction, the reducing agent according to the invention has the purpose of bonding the existing oxygen at room temperature. Furthermore, it must be ensured that, under discharge conditions and in the temperature range up to 900° C., the oxygen remains in the reducing agent and any further mercury oxide which is present is reduced. In this way, the formation of mercury oxide can be avoided or suppressed while the lamp is operating. To satisfy these conditions (bonding of oxygen in the range between room temperature and temperatures up to 900° C.), it is preferable to use a reducing agent which comprises a plurality of components. By way of example, the reducing agent may comprise a mixture of Fe and Zr, the mixing ratio being 4:1 (parts by mass). In a conventional fluorescent lamp, it is, for example, sufficient for approx. 40 mg of a mixture of this type to be introduced into the discharge vessel 2.

To activate this reducing agent, in the finished lamp it was heated at an activation temperature of approximately 800° C. by the application of a HF field for 15 seconds. This activation causes the oxides which are formed on the substance A (Fe) during introduction of the reducing agent 20 to be reduced by the substance B (Zr), so that the substance A is ready to bond oxygen at room temperature. After this activation, the lamp is ready for operation—the reducing agent comprising two components ensures that oxygen is bonded and any mercury oxide formed is reduced, so that the consumption of mercury can be lowered considerably compared to conventional solutions.

The advantageous effect of the solution according to the invention is explained with reference to a comparative example:

Two Hg-free three-band lamps, which were identical in terms of basic structure, were produced, one of the lamps containing a reducing agent according to the invention based on Fe/Zr, with the prescribed mixing ratio. In addition, 4 mg of pulverulent mercury oxide were introduced into both lamps. Both lamps were operated, and after a predetermined operating time tests were carried out to establish whether free mercury had formed. In the lamp according to the invention, it was possible to measure more than 0.2 mg of free mercury after an operating time of approx. 100 hours, while in the comparative lamp (without reducing agent) it was not possible to detect any free mercury after this time.

In a further series of tests, the reducing agent according to the invention was not activated before the lamps started to operate. In this test, it was impossible to detect any free mercury after an operating time of 100 hours. This can be explained by the fact that the substance A (Fe) has been oxidized by atmospheric oxygen while it was being introduced into the discharge vessel and therefore has no capacity to take up the oxygen under room conditions. Therefore, activation of the reducing agent must be an important feature at least when using the Fe/Zr combination. In principle, however, it is also possible for the substance B to be selected in such a manner that it is able to reduce even an unactivated substance A and mercury oxide which is present, so that the substance A is once again able to take up oxygen at room temperature.

All metals or metallic compounds which take up sufficient oxygen from the gas phase at 900° C. and are not amalgam-forming agents are considered to be suitable in principle as substance A for the intended application.

Substance B is to be selected in such a manner that its oxide has a higher bonding energy than the oxide of the substance A and is able to reduce the oxide of the substance A and the mercury oxide at temperatures of up to 900° C. The substances A and B are to be introduced into the discharge vessel with the largest possible surface area, and the mixing ratio is to be selected in such a way that the oxygen which is carried by substance A can be taken up by substance B.

The two components are preferably intimately mixed during introduction as a powder or a shaped body.

The invention discloses a low-pressure discharge lamp having a discharge vessel which contains mercury. To prevent mercury from being consumed, a reducing agent is introduced into the discharge vessel, which reducing agent is such that it bonds oxygen in the temperature range between room temperature and discharge conditions and, furthermore, can reduce mercury oxide.

List of reference symbols

| | |
|---|---|
| 1 | Low-pressure discharge lamp |
| 2 | Discharge vessel |
| 4 | Small pump tube |
| 6 | Phosphor coating |
| 8 | Electrode |
| 10 | Supply conductor |
| 12 | Supply conductor |
| 14 | Bead of glass |
| 16 | Discharge chamber |
| 18 | Annular cap |
| 20 | Reducing agent |

What is claimed is:

1. A low-pressure discharge lamp (1) having a discharge vessel (2) which accommodates two electrodes (18) and in which a fill comprising mercury and at least one inert gas is accommodated, and a reducing agent (20), by means of which oxygen which is present in the discharge vessel (2) is bonded in the temperature range between room temperature and temperatures up to 900° C. and mercury oxide can be reduced.

2. The low-pressure discharge lamp as claimed in claim 1, in which the reducing agent (20) includes a substance A which takes up oxygen in the temperature range below the discharge conditions and contains a substance B which, under discharge conditions and higher temperatures of up to 900° C., bonds oxygen which is released from the substance A and reduces mercury oxide.

3. The Low-pressure discharge lamp as claimed in claim 2, in which the substance A is a metal or a metallic compound which is not an amalgam-forming agent, and the substance B is a substance whose oxides have a higher bonding energy than the oxide of the substance A, so that, under discharge conditions, it can reduce the oxide of the substance A and can bond the oxygen.

4. The low-pressure discharge lamp as claimed in claim 2 or 3, in which the substance A is or contains Fe and the substance B is or contains Zr.

5. The low-pressure discharge lamp as claimed in claim 4, in which the mixing ratio of Fe to Zr is approximately 4:1.

6. The low-pressure discharge lamp as claimed in one of claims 2 to 5, in which the substance A contains oxides when it is being introduced into the discharge vessel (2), and the substance B is selected in such a way that it reduces these oxides and mercury oxide and stores oxygen.

7. The low-pressure discharge lamp as claimed in one of the preceding claims, in which the reducing agent (20) is introduced into the discharge vessel (2) as a powder or shaped body.

8. The low-pressure discharge lamp as claimed in one of claims 1 to 6, in which the reducing agent is introduced into the discharge vessel (2) as the coating of a substrate which also contains getter substances.

9. The low-pressure discharge lamp as claimed in one of claims 2 to 6, in which, after it has been introduced into the discharge chamber, the mixture is activated by increasing the temperature.

10. A reducing agent for a low-pressure discharge lamp as claimed in one of the preceding claims, having a substance A which takes up oxygen at room temperature and a substance B which, under discharge conditions and higher temperatures up to 900° C., reduces the oxide of the substance A and the mercury oxide and bonds oxygen which is released.

11. The reducing agent as claimed in claim 10, in which the substance A is a metal or a metallic compound which is not an amalgam-forming agent, and the substance B is a substance whose oxide has a higher bonding energy than the oxide of the substance A and of the mercury oxide.
